(19) United States
(12) Patent Application Publication
(10) Pub. No.: US 2025/0130052 A1
(43) Pub. Date: Apr. 24, 2025

(54) INFORMATION PROVIDING SYSTEM, INFORMATION PROVIDING DEVICE, INFORMATION PROVIDING METHOD, AND STORAGE MEDIUM

(71) Applicant: HONDA MOTOR CO., LTD., TOKYO (JP)

(72) Inventors: Tomohiro SUZUKI, TOKYO (JP); Takashi NOGUCHI, TOKYO (JP); Kaito FUJII, TOKYO (JP); Tomohiro SHIBATA, TOKYO (JP)

(21) Appl. No.: 18/921,727

(22) Filed: Oct. 21, 2024

(30) Foreign Application Priority Data
Oct. 24, 2023 (JP) 2023-182432

(51) Int. Cl. G01C 21/34; G01C 21/36

(52) U.S. Cl. CPC G01C 21/3438; G01C 21/362; G01C 21/3679; G01C 21/3697

(57) ABSTRACT

An information providing system includes terminal devices each of which is used by a user, and an information providing device capable of communicating with the terminal devices. The information providing device includes a group setting unit that sets a group including a plurality of users, an information acquisition unit that acquires information regarding movement of a moving object used by at least one of the users belonging to the group, and an information providing unit that provides the information regarding the movement of the moving object as acquired by the information acquisition unit, to the terminal devices used by the users belonging to the group.

### CROSS-REFERENCE TO RELATED APPLICATIONS

This application is based upon and claims the benefit of priority from Japanese Patent Application No. 2023-182432 filed on Oct. 24, 2023, the contents of which are incorporated herein by reference.

### BACKGROUND OF THE INVENTION

### Field of the Invention

The present invention relates to an information providing system, an information providing device, an information providing method, and a storage medium.

### Description of the Related Art

JP 2017-530463 A discloses a system in which a plurality of mobile terminals can share position information of each of the mobile terminals.

### SUMMARY OF THE INVENTION

A technique enabling information to be satisfactorily shared among a plurality of users who use terminal devices is demanded.

An object of the present invention is to solve the above-mentioned problem.

According to a first aspect of the present invention, provided is an information providing system comprising: terminal devices each of which is used by a user; and an information providing device configured to communicate with the terminal devices, wherein the information providing device includes: a group setting unit configured to set a group including a plurality of the users; an information acquisition unit configured to acquire information regarding movement of a moving object used by at least one of the users belonging to the group; and an information providing unit configured to provide the information regarding the movement of the moving object as acquired by the information acquisition unit, to the terminal devices used by the users belonging to the group.

According to a second aspect of the present invention, provided is an information providing device configured to communicate with terminal devices each of which is used by a user, the information providing device comprising: a group setting unit configured to set a group including a plurality of the users; an information acquisition unit configured to acquire information regarding movement of a moving object used by at least one of the users belonging to the group; and an information providing unit configured to provide the information regarding the movement of the moving object as acquired by the information acquisition unit, to the terminal devices used by the users belonging to the group.

According to a third aspect of the present invention, provided is an information providing method comprising: a group setting step of causing a group setting unit to set a group including a plurality of users; an information acquiring step of causing an information acquisition unit to acquire information regarding movement of a moving object used by at least one of the users belonging to the group; and an information providing step of causing an information providing unit to provide the information regarding the movement of the moving object as acquired in the information acquiring step, to terminal devices used by the users belonging to the group.

According to a fourth aspect of the present invention, provided is a non-transitory computer-readable storage medium configured to store a program for causing a computer to execute the information providing method according to the third aspect.

According to the present invention, information can be satisfactorily shared among a plurality of users who use terminal devices.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of an information providing system;

FIG. 2 is a functional block diagram of a mobile terminal;

FIG. 3 is a functional block diagram of an information providing device;

FIG. 4 is a functional block diagram of a moving object;

FIG. 5 is a flowchart of a group setting process performed by the information providing device;

FIG. 6 is a flowchart of an information providing process performed by the information providing device;

FIG. 7 is a diagram showing a display screen on which shared information is displayed;

FIG. 8 is a diagram showing the display screen on which the shared information is displayed;

FIG. 9 is a flowchart of a first additional process performed by the information providing device; and

FIG. 10 is a flowchart of a second additional process performed by the information providing device.

### DETAILED DESCRIPTION OF THE INVENTION

In a case where a first user of a first mobile terminal and a second user of a second mobile terminal meet each other, one or both of the users may head for a meeting place (a destination) by using a moving object such as a vehicle. However, the moving object may not be able to move as scheduled due to congestion, refueling, charging, or the like. In particular, electric vehicles require frequent charging, and each charging takes several tens of minutes. For such a reason, there may be a case where any of the users cannot arrive at the meeting place at the meeting time. In such a case, it is desirable that the user who cannot arrive at the meeting place at the meeting time contacts the other party. However, there is a problem that making contact is troublesome for the user. Further, there is a problem that it is difficult to operate the mobile terminal while driving.

An information providing system according to the present invention allows a plurality of users belonging to a preset group to share information regarding movement of a moving object. In the present specification, the information regarding the movement of the moving object is also referred to as moving object information.

### 1. CONFIGURATION OF INFORMATION PROVIDING SYSTEM 10

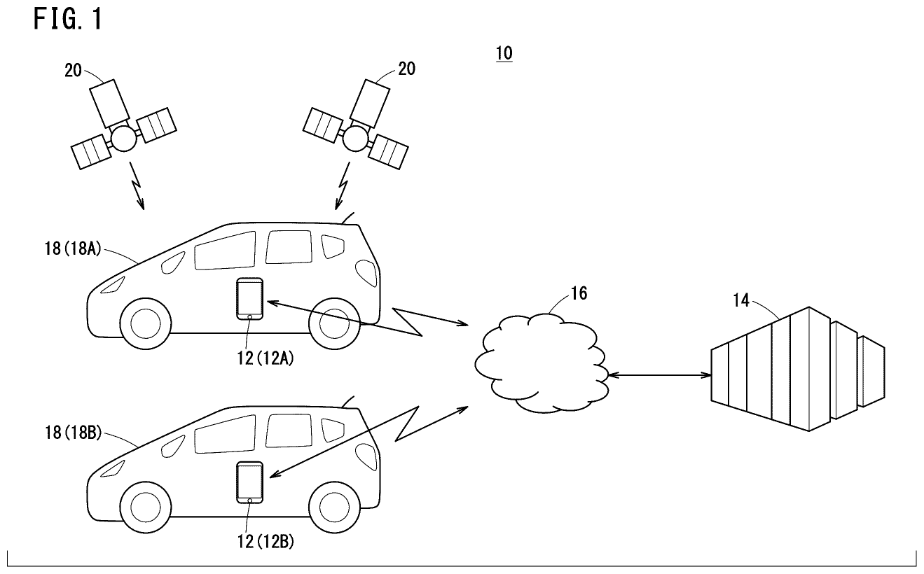

FIG. 1 is a schematic configuration diagram of an information providing system 10. The information providing system 10 includes a plurality of mobile terminals (terminal devices) 12 and an information providing device 14. Each of the mobile terminals 12 can be connected to a communication line 16 such as the Internet by wireless communication. The information providing device 14 can be connected to the communication line 16 by wired communication or wireless communication. The mobile terminals 12 and the information providing device 14 can perform bidirectional communication via the communication line 16.

The mobile terminals 12 are each carried by a user. When the user uses a moving object 18, the mobile terminal 12 is carried into the moving object 18. In the present specification, the moving object 18 is an electric vehicle driven by electric power supplied from a battery. Note that the moving object 18 may be a hybrid vehicle including an engine and a motor, or may be an engine vehicle. Further, the moving object 18 may be a moving object other than a vehicle.

The mobile terminal 12 is, for example, a smartphone or a tablet terminal, but is not limited thereto. For example, application software for information sharing is installed in the mobile terminal 12. In the following description, one of the plurality of mobile terminals 12 is also referred to as a first mobile terminal 12A, and another of the mobile terminals 12 other than the first mobile terminal 12A is also referred to as a second mobile terminal 12B. Further, the user of the first mobile terminal 12A is also referred to as a first user, and the user of the second mobile terminal 12B is also referred to as a second user. Furthermore, the moving object 18 in which the first user rides is also referred to as a first moving object 18A, and the moving object 18 in which the second user rides is also referred to as a second moving object 18B.

### 1-1. Configuration of Mobile Terminals 12

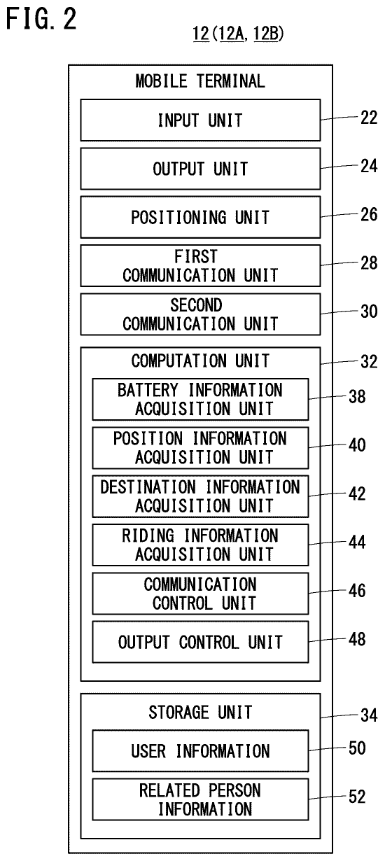

FIG. 2 is a functional block diagram of the mobile terminal 12. Here, the configuration of the first mobile terminal 12A among the mobile terminals 12 will be described. Note that the configuration of the second mobile terminal 12B is the same as the configuration of the first mobile terminal 12A. The first mobile terminal 12A includes an input unit 22, an output unit 24, a positioning unit 26, a first communication unit 28, a second communication unit 30, a computation unit 32, and a storage unit 34.

The input unit 22 includes a human machine interface for the first user to input various kinds of information to the first mobile terminal 12A. For example, the input unit 22 may include a keyboard, a touch panel, a voice input device, or the like.

The output unit 24 includes a human machine interface for outputting various kinds of information in a form that can be confirmed by the first user. For example, the output unit 24 may include a display device, a voice output device, or the like.

The positioning unit 26 includes a receiver for measuring the current location of the first mobile terminal 12A by satellite navigation. For example, the positioning unit 26 may include a global navigation satellite system (GNSS) receiver that receives radio waves from an artificial satellite 20 (FIG. 1).

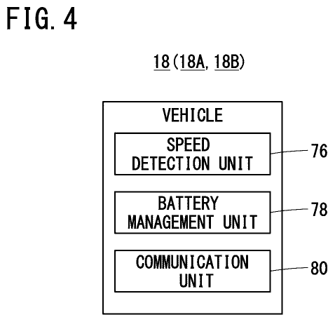

The first communication unit 28 includes a communication module (an integrated-circuit module) for performing wireless communication with a communication unit 80 (FIG. 4) of the first moving object 18A. For example, the first communication unit 28 may include a communication module for performing near field communication such as Bluetooth (registered trademark). The first communication unit 28 is wirelessly connected to the communication unit 80 of the first moving object 18A by pairing with the communication unit 80 of the first moving object 18A.

The second communication unit 30 includes a communication module (an integrated-circuit module) for performing bidirectional communication with another communication device (the information providing device 14) connected to the communication line 16.

The computation unit 32 can be constituted by a processor such as a central processing unit (CPU) or a graphics processing unit (GPU). That is, the computation unit 32 can be constituted by processing circuitry. At least part of the computation unit 32 may be realized by an integrated circuit such as an application specific integrated circuit (ASIC) or a field-programmable gate array (FPGA). At least part of the computation unit 32 may be realized by an electronic circuit including a discrete device.

The computation unit 32 includes a battery information acquisition unit 38, a position information acquisition unit 40, a destination information acquisition unit 42, a riding information acquisition unit 44, a communication control unit 46, and an output control unit 48. The battery information acquisition unit 38, the position information acquisition unit 40, the destination information acquisition unit 42, the riding information acquisition unit 44, the communication control unit 46, and the output control unit 48 can be realized by the computation unit 32 executing a program (application software for information sharing) stored in the storage unit 34.

The battery information acquisition unit 38 acquires information regarding the battery from a battery management unit 78 (FIG. 4) of the first moving object 18A via the first communication unit 28. The information regarding the battery includes a remaining battery level such as a state of charge (SOC), a charging recommendation threshold for recommending the first user to charge the battery, and the like. The remaining battery level is the moving object information. The charging recommendation threshold can be set in advance by the user, but the present invention is not limited thereto.

The position information acquisition unit 40 acquires information indicating the current location of the first mobile terminal 12A from the positioning unit 26. In a case where the first user rides in the first moving object 18A, the current location of the first mobile terminal 12A corresponds to the current location of the first moving object 18A. The current location of the first moving object 18A (the current location of the first mobile terminal 12A) is the moving object information.

The destination information acquisition unit 42 acquires information indicating the destination of the first moving object 18A from the input unit 22. In a case where the first user rides in the first moving object 18A, the first user operates the input unit 22 to input a destination to the first mobile terminal 12A. The information indicating the destination is stored in the storage unit 34. The destination is the moving object information.

The riding information acquisition unit 44 acquires information indicating whether or not the first user is riding in the first moving object 18A. For example, the riding information acquisition unit 44 acquires information indicating the traveling speed of the first moving object 18A from a speed detection unit 76 (FIG. 4) of the first moving object 18A via the first communication unit 28. Further, the riding information acquisition unit 44 may determine whether or not the first user is riding in the first moving object 18A based on the information indicating the traveling speed of the first moving object 18A and the information indicating the current location of the first moving object 18A as acquired by the position information acquisition unit 40. Specifically, in a case where the traveling speed of the first moving object 18A is zero in spite of the fact that the current location of the first mobile terminal 12A is moving, the riding information acquisition unit 44 determines that the first user is not riding in the first moving object 18A. The determination result of whether or not the first user is riding in the first moving object 18A is the moving object information.

The communication control unit 46 controls the second communication unit 30 to transmit, to the information providing device 14, the respective pieces of moving object information acquired by the battery information acquisition unit 38, the position information acquisition unit 40, the destination information acquisition unit 42, and the riding information acquisition unit 44.

The output control unit 48 controls the output unit 24 to output the moving object information of one or more moving objects 18 (the first moving object 18A and the second moving object 18B) provided by the information providing device 14.

The storage unit 34 is a computer-readable storage medium. The storage unit 34 is constituted by a volatile memory (not shown) and a non-volatile memory (not shown). The volatile memory is, for example, a random access memory (RAM) or the like. The non-volatile memory is, for example, a read only memory (ROM), a flash memory, or the like. Data and the like are stored in, for example, the volatile memory. Programs, tables, maps, and the like are stored in, for example, the non-volatile memory. At least part of the storage unit 34 may be included in the processor, the integrated circuit, or the like described above.

The storage unit 34 stores user information 50 and related person information 52. The user information 50 is information for identifying the first user and the first mobile terminal 12A. The user information 50 includes, for example, an identifier (a user ID or the like) of the first user, and an identifier (an individual identification number, a telephone number, or the like) of the first mobile terminal 12A. The related person information 52 includes an identifier (a user ID or the like) of the second user who is a related person of the first user, and an identifier (an individual identification number, a telephone number, or the like) of the second mobile terminal 12B. The related person information 52 includes information regarding at least one second user.

### 1-2. Configuration of Information Providing Device 14

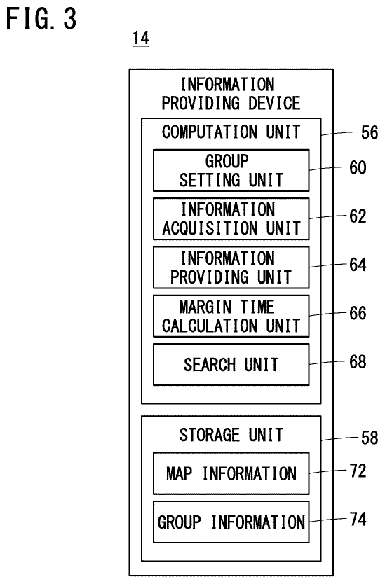

FIG. 3 is a functional block diagram of the information providing device 14. The information providing device 14 can be constituted by, for example, a physical server or a cloud server. The information providing device 14 includes a computation unit 56 and a storage unit 58.

The computation unit 56 can be constituted by a processor such as a CPU or a GPU. That is, the computation unit 56 can be constituted by processing circuitry. At least part of the computation unit 56 may be realized by an integrated circuit such as an ASIC or an FPGA. At least part of the computation unit 56 may be realized by an electronic circuit including a discrete device.

The computation unit 56 includes a group setting unit 60, an information acquisition unit 62, an information providing unit 64, a margin time calculation unit 66, and a search unit 68. The group setting unit 60, the information acquisition unit 62, the information providing unit 64, the margin time calculation unit 66, and the search unit 68 may be realized by the computation unit 56 executing a program stored in the storage unit 58.

The group setting unit 60 sets a group including a plurality of users. The group setting unit 60 stores, in the storage unit 58, group information 74 regarding the group that has been set. The group information 74 includes identification information of a group, identification information of users belonging to the group, and identification information of the mobile terminals 12 carried by the users belonging to the group.

The information acquisition unit 62 acquires the moving object information of the moving object 18 used by the user. The information acquisition unit 62 acquires, from the mobile terminal 12 carried by the user, at least one of information indicating the remaining battery level, information indicating the current location, information indicating the destination, or information indicating the presence or absence of an occupant. Further, the information acquisition unit 62 estimates an expected destination arrival time and a planned travel route, based on traffic information provided by an external device, the information indicating the current location, and the information indicating the destination. The expected destination arrival time is a time at which the moving object 18 is scheduled to arrive at the destination. The planned travel route is a route along which the moving object 18 is planned to travel from the current location to the destination. The expected destination arrival time and the planned travel route are the moving object information.

The information providing unit 64 provides the moving object information acquired by the information acquisition unit 62, to the mobile terminals 12 carried by the users belonging to the same group.

The margin time calculation unit 66 calculates the margin time. The margin time is a difference between one expected destination arrival time and another expected destination arrival time among the expected destination arrival times of the plurality of moving objects 18 having the same destination. For example, in a case where the destination of the first moving object 18A among the plurality of moving objects 18 matches the destination of the second moving object 18B among the plurality of moving objects 18, the margin time calculation unit 66 calculates the margin time based on the difference between the expected destination arrival time of the first moving object 18A and the expected destination arrival time of the second moving object 18B.

The search unit 68 searches map information 72 for a charging station at which both the first moving object 18A and the second moving object 18B can be charged.

The storage unit 58 is a computer-readable storage medium. The storage unit 58 is constituted by a volatile memory (not shown) and a non-volatile memory (not shown). The volatile memory is, for example, a RAM. The non-volatile memory is, for example, a ROM, a flash memory, or the like. Data and the like are stored in, for example, the volatile memory. Programs, tables, maps, and the like are stored in, for example, the non-volatile memory. At least part of the storage unit 58 may be included in the processor, the integrated circuit, or the like described above.

The storage unit 58 stores the map information 72. The map information 72 includes information regarding various facilities (charging stations and the like) in addition to information regarding nodes, links, and the like. The information regarding the various facilities includes information such as geographic coordinates, addresses, and telephone numbers of the facilities, and facility outlines.

The storage unit 58 stores the group information 74. As described above, the group information 74 includes the identification information of a group, the identification information of users belonging to the group, the identification information of the mobile terminals 12 carried by the users belonging to the group, and the like. The identification information of the group, the identification information of the users, and the identification information of the mobile terminals 12 carried by the users are associated with each other.

### 1-3. Configuration of Moving Objects 18

FIG. 4 is a functional block diagram of the moving object 18. The moving object 18 includes the speed detection unit 76, the battery management unit 78, and the communication unit 80. The speed detection unit 76 includes, for example, a speed sensor. The speed sensor detects the traveling speed of the moving object 18. The battery management unit 78 includes an electronic control unit (ECU). The battery management unit 78 calculates a remaining battery level such as a state of charge (SOC). The communication unit 80 includes a communication module (an integrated-circuit module) for performing wireless communication with the first communication unit 28 of the mobile terminal 12. For example, the communication unit 80 may include a communication module for performing near field communication such as Bluetooth (registered trademark).

### 2. OPERATION OF INFORMATION PROVIDING SYSTEM 10

### 2-1. Group Setting Process

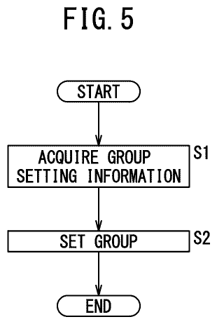

FIG. 5 is a flowchart of a group setting process performed by the information providing device 14. The user operates the mobile terminal 12 to instruct the information providing device 14 to set a group. The group setting process shown in FIG. 5 is performed at a timing when the information providing device 14 receives the instruction to set a group.

In step S1, the group setting unit 60 acquires group setting information. For example, the first user who wants to set a group operates the first mobile terminal 12A to select at least one second user and instructs the setting of a group. The first mobile terminal 12A transmits the group setting information in accordance with the user's operation to the information providing device 14. The group setting information includes identification information of users (the first user and at least one second user) to be registered in the group, identification information of the mobile terminal 12 carried by each user, and the like.

In step S2, the group setting unit 60 sets a group based on the acquired group setting information. The group setting unit 60 creates the group information 74 based on the group setting information acquired in step S1. The group setting unit 60 assigns identification information of an arbitrary group to the created group information 74.

### 2-2. Information Providing Process

Next, a process for sharing the moving object information by a plurality of users belonging to the same group will be described. Each user operates application software for information sharing in the mobile terminal 12. Each mobile terminal 12 transmits the moving object information and the user information 50 to the information providing device 14 at a predetermined timing.

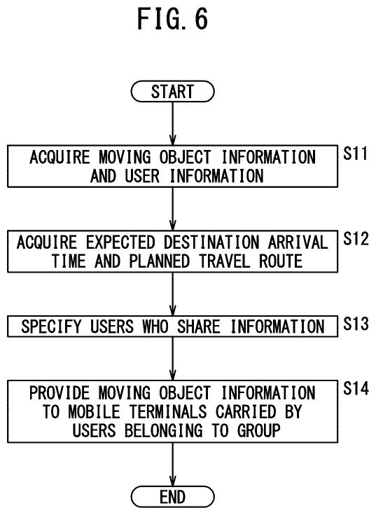

FIG. 6 is a flowchart of the information providing process performed by the information providing device 14. The information providing process shown in FIG. 6 is performed as needed. In this instance, a mode will be exemplified in which the second mobile terminal 12B carried by the second user shares the moving object information of the first moving object 18A used by the first user. The second user may be one person or a plurality of persons.

In step S11, the information acquisition unit 62 acquires the moving object information and the user information 50 transmitted from the first mobile terminal 12A.

In step S12, the information acquisition unit 62 estimates the expected destination arrival time and the planned travel route based on the traffic information provided by the external device, the acquired information indicating the current location, and the acquired information indicating the destination. Consequently, the information acquisition unit 62 acquires information indicating the expected destination arrival time and the planned travel route.

In step S13, the information providing unit 64 specifies the users who share the information, based on the group identification information acquired by the information acquisition unit 62 and the group information 74 stored in the storage unit 58. Specifically, based on the group information 74, the information providing unit 64 specifies the users belonging to the group in the group identification information. The information providing unit 64 may specify the users who share the information, based on the user information 50 acquired by the information acquisition unit 62 and the group information 74 stored in the storage unit 58.

In step S14, the information providing unit 64 provides the moving object information acquired by the information acquisition unit 62 to the mobile terminals 12 carried by the specified users. Accordingly, the moving object information of the first moving object 18A used by the first user is provided to the mobile terminals 12 of the users belonging to the group.

Consequently, the moving object information of the first moving object 18A used by the first user is shared by the users in the group to which the first user (and the second user) belong. The information providing device 14 performs the same process for the second mobile terminal 12B. Accordingly, the moving object information of the second moving object 18B used by the second user is also shared by the users in the group to which the second user (and the first user) belong.

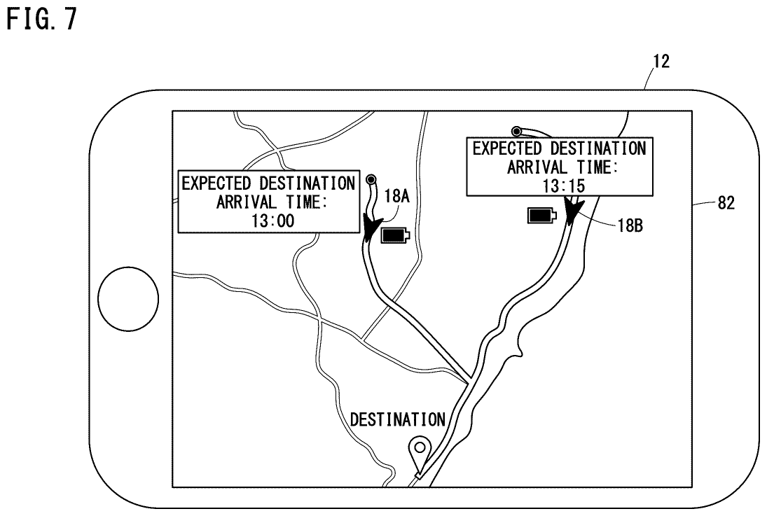

As described above, the information providing device 14 acquires the moving object information of each of the moving objects 18 and provides the acquired moving object information to each of the mobile terminals 12. As shown in FIG. 7, the output control unit 48 of each of the mobile terminals 12 displays, on a display screen 82, shared information including the moving object information (the remaining battery level, the current location, the destination, the expected destination arrival time, the planned travel route, and the like) of each of the moving objects 18 (18A, 18B).

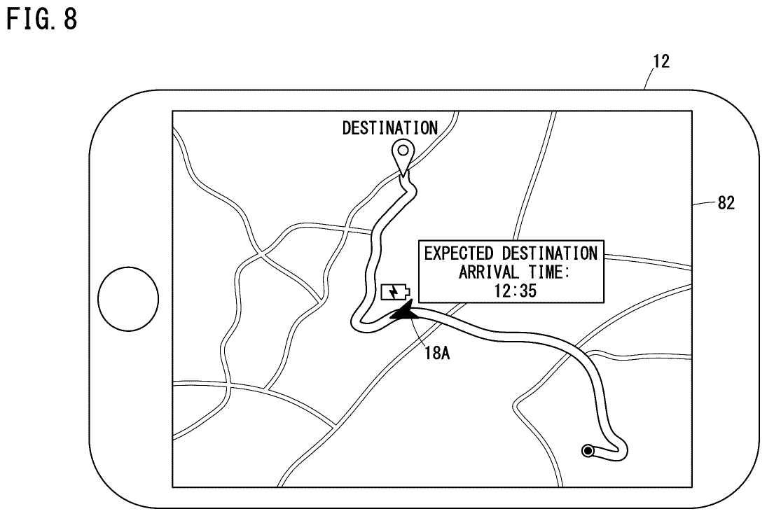

While the first user is riding in the first moving object 18A, the second user may not ride in the moving object 18. In this case, as shown in FIG. 8, the output control unit 48 of each of the first mobile terminal 12A and the second mobile terminal 12B displays, on the display screen 82, shared information including the moving object information (the remaining battery level, the current location, the destination, the expected destination arrival time, the planned travel route, and the like) of the first moving object 18A.

According to the information providing process described above, the user belonging to a group can automatically provide the moving object information regarding the moving object 18 to the other users belonging to the group. Therefore, even if the arrival time of the moving object 18 at the destination is expected to be delayed, the user does not need to contact the other users with the mobile terminal 12. Therefore, the user does not feel annoyed by contacting the other users. Further, each user can grasp what the other users are doing.

### 2-3. First Additional Process (Process for Providing Information Indicating Margin Time)

The information providing device 14 can provide further information to each of the moving objects 18 based on the moving object information.

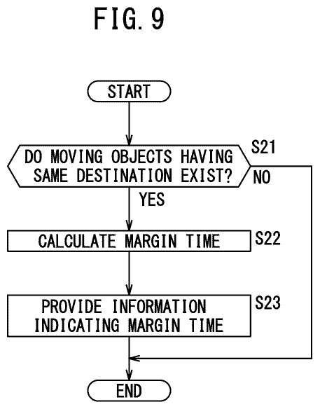

FIG. 9 is a flowchart of a first additional process performed by the information providing device 14. The first additional process shown in FIG. 9 is an information providing process for providing information to a user who uses each of a plurality of moving objects 18 having the same destination. The first additional process is a process for providing information indicating a margin time. As described above, the margin time is represented by the difference between one expected destination arrival time and another expected destination arrival time among the expected destination arrival times of the plurality of moving objects 18 having the same destination. The first additional process shown in FIG. 9 is executed after the process of step S13 of the information providing process shown in FIG. 6.

In step S21, the margin time calculation unit 66 determines whether or not moving objects 18 having the same destination exist in the group. In a case where the moving objects 18 having the same destination exist (step S21: YES), the process proceeds to step S22. On the other hand, in a case where the moving objects 18 having the same destination do not exist (step S21: NO), the first additional process is ended.

In step S22, the margin time calculation unit 66 selects one of the plurality of moving objects 18 having the same destination. For example, the moving object 18 whose expected destination arrival time is the latest is selected from among the plurality of moving objects 18 having the same destination. Further, the margin time calculation unit 66 calculates a difference (a margin time) between the expected destination arrival time of the selected moving object 18 and the expected destination arrival time of other moving object 18 having the same destination as the selected moving object 18.

In step S23, the information providing unit 64 provides information indicating the margin time calculated by the margin time calculation unit 66, to the mobile terminals 12 carried by the users who use the moving objects 18 having the same destination. For example, in a case where the expected destination arrival time of the first moving object 18A is 30 minutes later than the expected destination arrival time of the second moving object 18B, the information providing unit 64 provides information indicating the margin time of 30 minutes to the second mobile terminal 12B. Note that the information providing unit 64 may provide, to the first mobile terminal 12A, information indicating that the expected destination arrival time of the first moving object 18A is 30 minutes later than the expected destination arrival time of the second moving object 18B.

According to the first additional process described above, the user is notified of the margin time. Therefore, the user can effectively utilize the margin time.

### 2-4. Second Additional Process (Process for Providing Information Regarding Charging Stations)

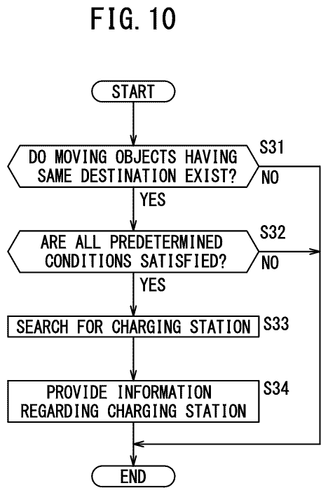

FIG. 10 is a flowchart of a second additional process performed by the information providing device 14. The second additional process shown in FIG. 10 is an information providing process for providing information to a user who uses each of a plurality of moving objects 18 having the same destination. The second additional process is a process for providing information regarding charging stations. The information regarding the charging stations includes information such as geographic coordinates, addresses, telephone numbers, and facility outlines of the charging stations. The second additional process shown in FIG. 10 is executed after the process of step S13 of the information providing process shown in FIG. 6.

In step S31, the search unit 68 determines whether or not moving objects 18 having the same destination exist in the group. In a case where the moving objects 18 having the same destination exist (step S31: YES), the process proceeds to step S32. On the other hand, in a case where the moving objects 18 having the same destination do not exist (step S31: NO), the second additional process is ended.

In step S32, the search unit 68 determines whether or not all predetermined conditions for searching for a charging station are satisfied. In this instance, it is assumed that the destination of the first moving object 18A matches the the destination of the second moving object 18B. In a case where the remaining battery level of the first moving object 18A is equal to or lower than a charging recommendation threshold for the first moving object 18A, the search unit 68 determines that a first predetermined condition is satisfied. In a case where the remaining battery level of the second moving object 18B is equal to or lower than a charging recommendation threshold for the second moving object 18B, the search unit 68 determines that a second predetermined condition is satisfied. In a case where the separation distance between the current location of the first moving object 18A and the current location of the second moving object 18B is equal to or less than a predetermined distance, the search unit 68 determines that a third predetermined condition is satisfied. In a case where all the predetermined conditions are satisfied (step S32: YES), the process proceeds to step S33. On the other hand, in a case where any of the predetermined conditions is not satisfied (step S32: NO), the second additional process is ended.

In step S33, the search unit 68 searches for a charging station. For example, the search unit 68 searches the map information 72 for a charging station which is located within a predetermined distance from both the current location of the first moving object 18A and the current location of the second moving object 18B, and at which the first moving object 18A and the second moving object 18B can be simultaneously charged.

In step S34, the information providing unit 64 provides information regarding the charging station searched by the search unit 68, to each of the mobile terminals 12 (the first mobile terminal 12A and the second mobile terminal 12B). The information providing unit 64 may provide information regarding a plurality of charging stations to each of the mobile terminals 12. The information providing unit 64 may preferentially provide, to each of the mobile terminals 12, information regarding a charging station that is located in the traveling direction of the first moving object 18A and the second moving object 18B and that is closest to the current location of the first moving object 18A and the current location of the second moving object 18B.

According to the second additional process described above, a plurality of users can meet at the same charging station and charge their respective moving objects 18 at the same time.

Note that a terminal device (for example, a navigation device) provided in the moving object 18 may be used instead of the mobile terminal 12.

The computer program (computer software) according to the present embodiment may be referred to as a computer program product. The computer program product includes a computer program transmitted, distributed, or downloaded via the Internet or the like, in addition to a computer program stored in a storage medium.

### 3. SUPPLEMENTARY NOTES

The following supplementary notes are further disclosed in relation to the above-described disclosure.

### Supplementary Note 1

Provided is the information providing system (10) including the terminal devices (12, 12A, 12B) each of which is used by a user, and the information providing device (14) configured to communicate with the terminal devices, wherein the information providing device includes the group setting unit (60) configured to set a group including a plurality of the users, the information acquisition unit (62) configured to acquire information regarding movement of the moving object (18, 18A, 18B) used by at least one of the users belonging to the group, and the information providing unit (64) configured to provide the information regarding the movement of the moving object as acquired by the information acquisition unit, to the terminal devices used by the users belonging to the group.

According to the above configuration, the user belonging to a group can automatically provide the moving object information regarding the moving object to the other users belonging to the group. Therefore, even if the arrival time of the moving object at the destination is expected to be delayed, the user does not need to contact the other users with the terminal device (the mobile terminal). Therefore, the user does not feel annoyed by contacting the other users. Further, each user can grasp what the other users are doing.

### Supplementary Note 2

In the information providing system according to supplementary note 1, the moving object may be an electric vehicle driven by electric power supplied from the battery, and the information regarding the movement of the moving object may include at least one of the remaining battery level, the current location, the destination, the expected destination arrival time, the planned travel route, or the presence or absence of an occupant.

### Supplementary Note 3

The information providing system according to supplementary note 2 may further include the margin time calculation unit (66) configured to calculate the margin time based on a difference between the expected destination arrival time of the first moving object (18A) among a plurality of the moving objects and the expected destination arrival time of the second moving object (18B) among the plurality of moving objects, in a case where the destination of the first moving object matches the destination of the second moving object, and the information providing unit may provide the information indicating the margin time to at least either the terminal device used by the user who uses the first moving object or the terminal device used by the user who uses the second moving object.

According to the above configuration, the user is notified of the margin time. Therefore, the user can effectively utilize the margin time.

### Supplementary Note 4

In the information providing system according to supplementary note 2, the charging recommendation threshold for recommending each of the users to charge the battery may be set in advance, the information providing device may further include the search unit (68) configured to search for a charging station at which both the first moving object among the plurality of moving objects and the second moving object among the plurality of moving objects are chargeable together, in a case where the destination of the first moving object matches the destination of the second moving object, the remaining battery level of the first moving object is equal to or less than the charging recommendation threshold for the first moving object, the remaining battery level of the second moving object is equal to or less than the charging recommendation threshold for the second moving object, and a distance between the current location of the first moving object and the current location of the second moving object is equal to or less than a predetermined distance, and the information providing unit may provide the information regarding the charging station searched by the search unit, to the terminal device used by the user who uses the first moving object and the terminal device used by the user who uses the second moving object.

According to the above configuration, a plurality of users can meet at the same charging station and charge their respective moving objects at the same time.

### Supplementary Note 5

In the information providing system according to any one of supplementary notes 1 to 4, the terminal devices may be mobile terminals carried by the users.

### Supplementary Note 6

Provided is the information providing device configured to communicate with the terminal devices each of which is used by a user, the information providing device including the group setting unit configured to set a group including a plurality of the users, the information acquisition unit configured to acquire information regarding movement of the moving object used by at least one of the users belonging to the group, and the information providing unit configured to provide the information regarding the movement of the moving object as acquired by the information acquisition unit, to the terminal devices used by the users belonging to the group.

### Supplementary Note 7

Provided is the information providing method including: the group setting step of causing the group setting unit to set a group including a plurality of users; the information acquiring step of causing the information acquisition unit to acquire information regarding movement of the moving object used by at least one of the users belonging to the group; and the information providing step of causing the information providing unit to provide the information regarding the movement of the moving object as acquired in the information acquiring step, to the terminal devices used by the users belonging to the group.

### Supplementary Note 8

Provided is the storage medium configured to store the program for causing a computer to execute the information providing method according to supplementary note 7.

It should be noted that the present invention is not limited to the above disclosure, and various modifications are possible without departing from the essence and gist of the present invention.

1. An information providing system comprising:
terminal devices each of which is used by a user;
an information providing device configured to communicate with the terminal devices; and
one or more processors that execute computer-executable instructions stored in a memory,
wherein the one or more processors execute the computer-executable instructions to cause the information providing device to:
set a group including a plurality of the users;
acquire information regarding movement of a moving object used by at least one of the users belonging to the group; and
provide the acquired information regarding the movement of the moving object, to the terminal devices used by the users belonging to the group.

2. The information providing system according to claim 1, wherein
the moving object is an electric vehicle driven by electric power supplied from a battery, and
the information regarding the movement of the moving object includes at least one of a remaining battery level, a current location, a destination, an expected destination arrival time, a planned travel route, or presence or absence of an occupant.

3. The information providing system according to claim 2, wherein
the one or more processors cause the information providing device to:
calculate a margin time based on a difference between the expected destination arrival time of a first moving object among a plurality of the moving objects and the expected destination arrival time of a second moving object among the plurality of moving objects, in a case where the destination of the first moving object matches the destination of the second moving object; and
provide information indicating the margin time to at least either the terminal device used by the user who uses the first moving object or the terminal device used by the user who uses the second moving object.

4. The information providing system according to claim 2, wherein
a charging recommendation threshold for recommending each of the users to charge the battery is set in advance, and
the one or more processors cause the information providing device to:
search for a charging station at which both a first moving object among a plurality of the moving objects and a second moving object among the plurality of moving objects are chargeable together, in a case where the destination of the first moving object matches the destination of the second moving object, the remaining battery level of the first moving object is equal to or less than the charging recommendation threshold for the first moving object, the remaining battery level of the second moving object is equal to or less than the charging recommendation threshold for the second moving object, and a distance between the current location of the first moving object and the current location of the second moving object is equal to or less than a predetermined distance; and
provide information regarding the charging station that has been searched, to the terminal device used by the user who uses the first moving object and the terminal device used by the user who uses the second moving object.

5. The information providing system according to claim 1, wherein
the terminal devices are mobile terminals carried by the users.

6. An information providing device configured to communicate with terminal devices each of which is used by a user, the information providing device comprising:
one or more processors that execute computer-executable instructions stored in a memory, wherein
the one or more processors execute the computer-executable instructions to cause the information providing device to:
set a group including a plurality of the users;
acquire information regarding movement of a moving object used by at least one of the users belonging to the group; and
provide the acquired information regarding the movement of the moving object, to the terminal devices used by the users belonging to the group.

7. An information providing method comprising:
setting a group including a plurality of users;
acquiring information regarding movement of a moving object used by at least one of the users belonging to the group; and
providing the acquired information regarding the movement of the moving object to terminal devices used by the users belonging to the group.

8. A non-transitory computer-readable storage medium configured to store a program for causing a computer to execute the information providing method according to claim 7.
